(19) United States
(12) Patent Application Publication
(10) Pub. No.: US 2022/0091532 A1
(43) Pub. Date: Mar. 24, 2022

(54) IMAGE FORMING APPARATUS AND LIGHT-EMITTING-DEVICE HEAD

(71) Applicant: FUJI XEROX CO., LTD., Tokyo (JP)

(72) Inventors: Shigeru ARAI, Kanagawa (JP); Kyoji YAGI, Kanagawa (JP); Ken TSUCHIYA, Kanagawa (JP)

(73) Assignee: FUJI XEROX CO., LTD., Tokyo (JP)

(21) Appl. No.: 17/149,093

(22) Filed: Jan. 14, 2021

(30) Foreign Application Priority Data
Sep. 24, 2020 (JP) 2020-159617

(51) Int. Cl. G03G 15/043; G03G 15/04

(52) U.S. Cl. CPC G03G 15/043; G03G 15/04054

(57) ABSTRACT

An image forming apparatus includes a toner-image-forming unit that forms a toner image by using a first light-emitting-device arrangement and a second light-emitting-device arrangement in each of which light-emitting devices are arranged in lines extending in a first scanning direction, the second light-emitting-device arrangement overlapping the first light-emitting-device arrangement in a second scanning direction at least in part, and an optical device that forms an electrostatic latent image by focusing light emitted from the light-emitting devices on a photoconductor and exposing the photoconductor to the light; a transfer unit that transfers the toner image to a recording medium; a fixing unit that fixes the toner image transferred to the recording medium and finishes the image; a switching unit that switches the light-emitting-device arrangement to be lit up between the first light-emitting-device arrangement and the second light-emitting-device arrangement at a switching position defined at any position in an overlapping portion where the first light-emitting-device arrangement and the second light-emitting-device arrangement overlap each other; an acquiring unit that acquires information on density variation at the switching position in the image formed on the recording medium; and a correcting unit that corrects the density variation with reference to the information on density variation.

### CROSS-REFERENCE TO RELATED APPLICATIONS

This application is based on and claims priority under 35 USC 119 from Japanese Patent Application No. 2020-159617 filed Sep. 24, 2020.

### BACKGROUND

### (i) Technical Field

The present disclosure relates to an image forming apparatus and a light-emitting-device head.

### (ii) Related Art

An electrophotographic image forming apparatus, such as a printer; a multifunction machine; or a facsimile, forms an image by applying light representing image information from an optical recording unit to a charged photoconductor to form an electrostatic latent image, visualizing the electrostatic latent image with toner, transferring the visualized image to a recording medium, and fixing the image. Examples of the optical recording unit include a unit employing an optical scanning scheme in which the unit performs exposure by moving laser light of a laser in a first scanning direction. A recent optical recording unit employs a light-emitting-device head in which a number of light emitting devices such as light emitting diodes (LEDs) are arranged in the first scanning direction.

In an image forming apparatus disclosed by Japanese Unexamined Patent Application Publication No. 2017-37217, a scanning unit reads a test chart formed on a recording medium by an image forming unit. A controller identifies the image density of the test chart read by the scanning unit, for each of different areas of the image that are defined in correspondence with LED-print-head (LPH) chips included in an exposure device. With reference to the image density of the test chart, the controller identifies the correction amount for the quantity of light to be emitted from the LPH chips. In accordance with the correction amount thus identified, the controller corrects the quantity of light to be emitted from the chips. Then, another image of the test chart is formed with the LPH chips whose light quantity has been corrected, and the image thus formed is read by the scanning unit. Subsequently, the controller identifies the correction amount for the quantity of light to be emitted from the LPH chips with reference to the image density of the test chart, and changes the coefficient for the adjustment of the correction amount with reference to the correction amount thus identified and the previously identified correction amount.

### SUMMARY

It is difficult to manufacture a light-emitting-device head in which light emitting devices that are arranged in the first scanning direction are all provided on a single substrate. Therefore, in some cases, a plurality of substrates are arranged in a staggered manner in the first scanning direction while overlapping one another in part in a second scanning direction, and the substrate to be used for light emission is switched at each of the overlapping portions. In such a case, however, the image formed on the recording medium may have density variations at each of switching positions where the above switching occurs.

Aspects of non-limiting embodiments of the present disclosure relate to an image forming apparatus and so forth in which an image formed on a recording medium is less likely to have density variations at each position for switching light emitting devices to be lit up than in a case where no correcting unit that corrects density variation is provided.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including a toner-image-forming unit that forms a toner image by using a first light-emitting-device arrangement and a second light-emitting-device arrangement in each of which light-emitting devices are arranged in lines extending in a first scanning direction, the second light-emitting-device arrangement overlapping the first light-emitting-device arrangement in a second scanning direction at least in part, and an optical device that forms an electrostatic latent image by focusing light emitted from the light-emitting devices on a photoconductor and exposing the photoconductor to the light; a transfer unit that transfers the toner image to a recording medium; a fixing unit that fixes the toner image transferred to the recording medium and finishes the image; a switching unit that switches the light-emitting-device arrangement to be lit up between the first light-emitting-device arrangement and the second light-emitting-device arrangement at a switching position defined at any position in an overlapping portion where the first light-emitting-device arrangement and the second light-emitting-device arrangement overlap each other; an acquiring unit that acquires information on density variation at the switching position in the image formed on the recording medium; and a correcting unit that corrects the density variation with reference to the information on density variation.

### BRIEF DESCRIPTION OF THE DRAWINGS

An exemplary embodiment of the present disclosure will be described in detail based on the following figures, wherein:

FIG. 1 illustrates an outline of an image forming apparatus according to an exemplary embodiment;

FIG. 2 illustrates a configuration of a light-emitting-device head to which the exemplary embodiment is applied;

FIG. 3A is a perspective view of a circuit board and a light emitting unit included in the light-emitting-device head; FIG. 3B is an enlargement of a part of the light emitting unit seen in a direction of arrow IIIB illustrated in FIG. 3A;

FIGS. 4A and 4B illustrate a configuration of a light emitting chip to which the exemplary embodiment is applied;

FIG. 5 illustrates a configuration of a signal generating circuit and a wiring scheme of the circuit board in a case where self-scanning light-emitting-device-array chips are employed as the light emitting chips;

FIG. 6 illustrates a circuit configuration of the light emitting chip;

FIGS. 7A and 7B illustrate the relationship between a defocused image and the density thereof;

FIGS. 8A to 8D illustrate focus variations between adjacent ones of LPH bars and an image formed with the focus variations;

FIG. 9 is a block diagram illustrating an exemplary functional configuration of the signal generating circuit according to the exemplary embodiment; and

FIG. 10 is a flow chart of an operation executed by the image forming apparatus in a case where an acquiring unit is an image reading device and a correcting unit is a pair of focus adjusting pins;

FIGS. 11A to 11C illustrate images of a test pattern printed in step 101;

FIG. 12 is a flow chart of an operation executed by the image forming apparatus in a case where the acquiring unit is a user interface (UI) and the correcting unit is the pair of focus adjusting pins;

FIG. 13 is a flow chart of an operation executed by the image forming apparatus in a case where the acquiring unit is the image reading device and the correcting unit is a light-quantity-correcting mechanism; and

FIGS. 14A and 14B each illustrate how to correct the light quantity of LEDs positioned in a double portion and LEDs positioned adjacent to the double portion.

### DETAILED DESCRIPTION

### Description of Overall Configuration of Image Forming Apparatus

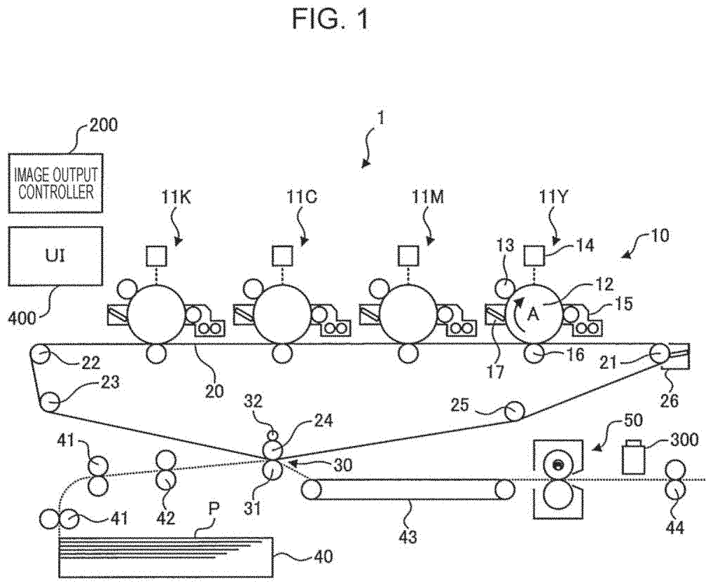

FIG. 1 illustrates an outline of an image forming apparatus 1 according to an exemplary embodiment.

The image forming apparatus 1 is a so-called tandem image forming apparatus. The image forming apparatus 1 includes an image forming section 10 that forms an image in correspondence with pieces of image data for different colors. The image forming apparatus 1 further includes an intermediate transfer belt 20 that carries toner images formed with different color components by respective image forming units 11 and sequentially transferred thereto (first transfer). The image forming apparatus 1 further includes a second transfer device 30 that collectively transfers the toner images from the intermediate transfer belt 20 to a sheet P (second transfer). The sheet P is an exemplary recording medium. The image forming apparatus 1 further includes a fixing device 50 that fixes the second-transferred toner images on the sheet P, thereby finishing the image. The fixing device 50 is an exemplary fixing unit. The image forming apparatus 1 further includes an image output controller 200 that controls relevant mechanical elements of the image forming apparatus 1 and executes a predetermined imaging process on the image data.

The image forming apparatus 1 further includes an image reading device 300 that reads an image formed on the sheet P by the image forming section 10. The image reading device 300 reads the image for the adjustment of the image. The image forming apparatus 1 further includes a user interface (UI) 400 such as a touch panel. The UI 400 outputs an instruction made by a user to the image output controller 200 and provides information received from the image output controller 200 to the user.

The image forming section 10 includes, for example, a plurality (four in the present exemplary embodiment) of image forming units 11 (specifically, 11Y (yellow), 11M (magenta), 11C (cyan), and 11K (black)) that electrophotographically form toner images with respective color components. The image forming units 11 are each an exemplary toner-image-forming unit that forms a toner image.

The image forming units 11 (11Y, 11M, 11C, and 11K) all have the same configuration except the colors of toner to be used. Therefore, the yellow image forming unit 11Y is taken as an example in the following description. The yellow image forming unit 11Y includes a photoconductor drum 12 having a photosensitive layer (not illustrated) and rotatable in a direction of arrow A. The photoconductor drum 12 is surrounded by a charging roller 13, a light-emitting-device head 14, a developing device 15, a first transfer roller 16, and a drum cleaner 17. The charging roller 13 is rotatably in contact with the photoconductor drum 12 and charges the photoconductor drum 12 to a predetermined potential. The light-emitting-device head 14 applies light to the photoconductor drum 12 charged to the predetermined potential by the charging roller 13 and forms an electrostatic latent image thereon. The developing device 15 contains toner of a corresponding one of the color components (yellow toner for the yellow image forming unit 11Y). The toner is used for developing the electrostatic latent image on the photoconductor drum 12. The first transfer roller 16 first-transfers the toner image from the photoconductor drum 12 to the intermediate transfer belt 20. The drum cleaner 17 removes residual matter (toner and so forth) from the photoconductor drum 12 having undergone first transfer.

The photoconductor drum 12 serves as an image carrying member that carries an image. The charging roller 13 serves as a charging unit that charges the surface of the photoconductor drum 12. The light-emitting-device head 14 serves as an electrostatic-latent-image-forming unit (a lighting device) that exposes the photoconductor drum 12 to light and thus forms an electrostatic latent image on the photoconductor drum 12. The developing device 15 serves as a developing unit that develops the electrostatic latent image into a toner image.

The intermediate transfer belt 20 as an image transfer member is stretched around and rotatably supported by a plurality (five in the present exemplary embodiment) of supporting rollers. The supporting rollers include a driving roller 21 that stretches the intermediate transfer belt 20 and drives the intermediate transfer belt 20 to rotate. The supporting rollers further include stretching rollers 22 and 25 that stretch the intermediate transfer belt 20 and rotate by following the intermediate transfer belt 20 driven by the driving roller 21. A correction roller 23 stretches the intermediate transfer belt 20 and serves as a steering roller (tiltable on one axial end thereof) that suppresses the meandering of the intermediate transfer belt 20 in a direction substantially orthogonal to the direction of transport. A backup roller 24 stretches the intermediate transfer belt 20 and serves as a member included in the second transfer device 30 to be described below.

A belt cleaner 26 that removes residual matter (toner and so forth) from the intermediate transfer belt 20 having undergone second transfer is provided across the intermediate transfer belt 20 from the driving roller 21.

Although details are to be described below, the image forming unit 11 according to the present exemplary embodiment forms a density-correction image (a reference patch or a density-correction toner image) having a predetermined density intended for correction of image density. The density-correction image is an exemplary image for adjusting the state of the apparatus.

The second transfer device 30 includes a second transfer roller 31 pressed against a side of the intermediate transfer belt 20 on which the toner images are to be carried, and the backup roller 24 positioned on the other side of the intermediate transfer belt 20 and serving as a counter electrode to the second transfer roller 31. A power feeding roller 32 that applies a second transfer bias to the backup roller 24 is provided in contact with the backup roller 24. The second transfer bias has the polarity with which the toner is charged. The second transfer roller 31 is grounded.

In the image forming apparatus 1 according to the present exemplary embodiment, a set of the intermediate transfer belt 20, the first transfer rollers 16, and the second transfer roller 31 serves as a transfer unit that transfers the toner images to the sheet P.

A sheet transporting system includes a sheet tray 40, transporting rollers 41, a registration roller 42, a transporting belt 43, and a discharge roller 44. In the sheet transporting system, the transporting rollers 41 transport one of the sheets P stacked on the sheet tray 40. Then, the registration roller 42 temporarily stops the sheet P, and transports the sheet P to a second transfer position in the second transfer device 30 at a predetermined timing. Subsequently, the transporting belt 43 transports the sheet P having undergone second transfer to the fixing device 50. Then, the discharge roller 44 receives the sheet P from the fixing device 50 and discharges the sheet P to the outside.

The image reading device 300, which is also called “inline sensor”, is positioned on the downstream side with respect to the fixing device 50 in the direction of transport of the sheet P. The image reading device 300 reads the image obtained after the fixing of the toner images on the sheet P by the fixing device 50.

The image reading device 300 includes a light source, an optical system, and a charge-coupled-device (CCD) sensor (not illustrated). The image reading device 300 applies light from the light source to the image, receives the light reflected by the image, and focuses the received light on the CCD sensor through the optical system. The CCD sensor includes an array of CCDs serving as pixels that receive the light reflected by the image. In the present exemplary embodiment, three rows of CCDs are provided in correspondence with the three colors of R (red), G (green), and B (blue) and measure the respective colors of R, G, and B of the image. The image reading device 300 according to the present exemplary embodiment reads the image fixed on the sheet P. Alternatively, the image reading device 300 may read the toner images formed on the intermediate transfer belt 20.

Now, a basic imaging process performed by the image forming apparatus 1 will be described. When a start switch (not illustrated) is turned on, a predetermined imaging process is executed. Specifically, if the image forming apparatus 1 is configured as a printer for example, the image output controller 200 first receives image data inputted from an external apparatus such as a personal computer (PC). The image data thus received is subjected to an imaging process performed by the image output controller 200 and is supplied to the image forming units 11. Then, the image forming units 11 form toner images in the respective colors. Specifically, the image forming units 11 (specifically, 11Y, 11M, 11C, and 11K) are activated in accordance with digital image signals for the respective colors. In each of the image forming units 11, light representing the digital image signal is applied from the light-emitting-device head (LPH) 14 to the photoconductor drum 12 charged by the charging roller 13, whereby an electrostatic latent image is formed. Then, the electrostatic latent image formed on the photoconductor drum 12 is developed by the developing device 15 into a toner image in a corresponding one of the colors. If the image forming apparatus 1 is configured as a multifunction machine, a document that is set on a document table (not illustrated) is read by a scanner, a signal obtained by the reading is converted into a digital image signal by a processing circuit, and toner images in the respective colors are formed as described above.

Subsequently, the toner images formed on the respective photoconductor drums 12 are sequentially first-transferred to the surface of the intermediate transfer belt 20 by the respective first transfer rollers 16 at respective first transfer positions where the respective photoconductor drums 12 are in contact with the intermediate transfer belt 20. Meanwhile, residual toner on the photoconductor drums 12 having undergone first transfer is removed by the respective drum cleaners 17.

Thus, the toner images first-transferred to the intermediate transfer belt 20 are superposed one on top of another on the intermediate transfer belt 20 and are transported to the second transfer position with the rotation of the intermediate transfer belt 20. Meanwhile, a sheet P is transported to the second transfer position at a predetermined timing and is nipped between the backup roller 24 and the second transfer roller 31 pressed toward the backup roller 24.

At the second transfer position, the toner images carried by the intermediate transfer belt 20 are second-transferred to the sheet P by the effect of a transfer electric field generated between the second transfer roller 31 and the backup roller 24. The sheet P now having the toner images is transported to the fixing device 50 by the transporting belt 43. The fixing device 50 fixes the toner images on the sheet P by applying heat and pressure to the toner images. Then, the sheet P is transported to the sheet output tray (not illustrated) provided outside the apparatus. Meanwhile, residual toner on the intermediate transfer belt 20 having undergone second transfer is removed by the belt cleaner 26.

### Description of Light-Emitting-Device Head 14

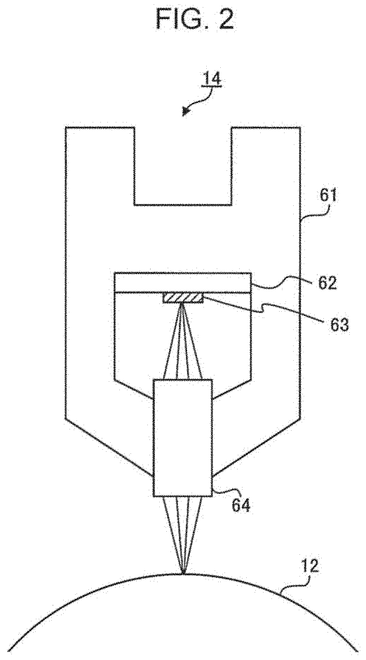

FIG. 2 illustrates a configuration of the light-emitting-device head 14 to which the exemplary embodiment is applied.

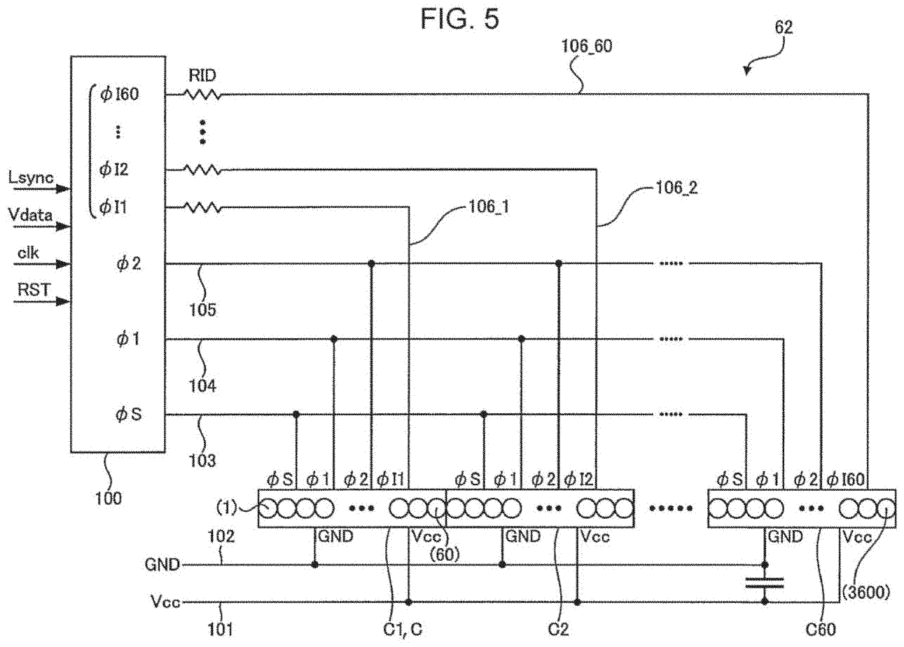

The light-emitting-device head 14 includes a housing 61, a light emitting unit 63 including a plurality of LEDs as light emitting devices, a circuit board 62 carrying elements such as the light emitting unit 63 and a signal generating circuit 100 (see FIG. 5 to be referred to below), and a rod lens (radial-gradient-index lens) array 64 as an exemplary optical device that forms an electrostatic latent image by focusing the light emitted from the LEDs on the photoconductor drum 12 and exposing the photoconductor drum 12 to the light.

The housing 61 is made of metal, for example. The housing 61 supports the circuit board 62 and the rod lens array 64 such that the point of light emission from the light emitting unit 63 coincides with the focal plane of the rod lens array 64. The rod lens array 64 extends in the axial direction (a first scanning direction) of the photoconductor drum 12.

### Description of Light Emitting Unit 63

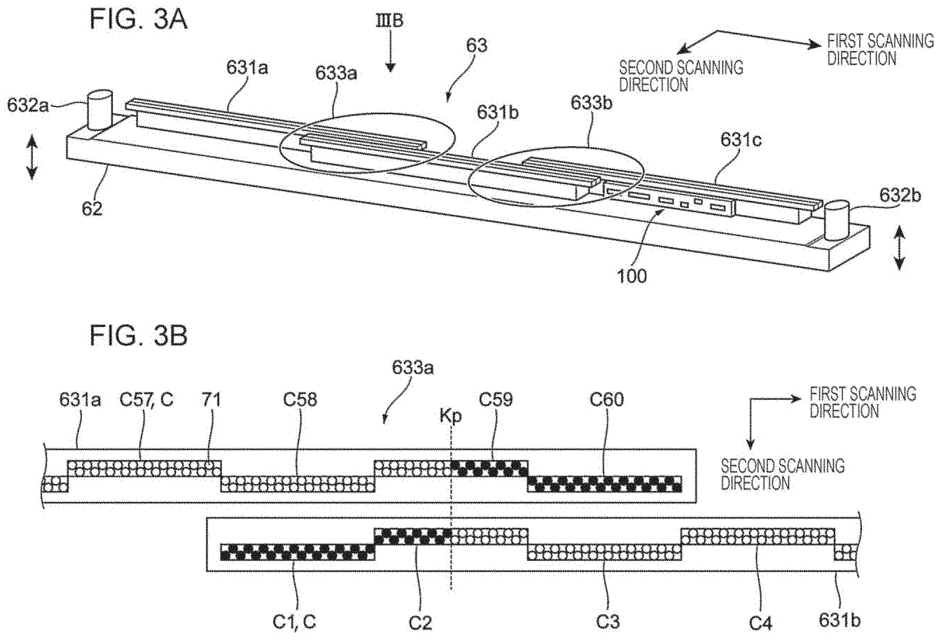

FIG. 3A is a perspective view of the circuit board 62 and the light emitting unit 63 included in the light-emitting-device head 14.

As illustrated in FIG. 3A, the light emitting unit 63 includes LPH bars 631a to 631c, focus adjusting pins 632a and 632b, and the signal generating circuit 100 as an exemplary controller that controls the light emission from the LEDs.

The LPH bars 631a to 631c are arranged on the circuit board 62 in a staggered manner in the first scanning direction. Each two of the LPH bars 631a to 631c that are adjacent in the first scanning direction overlap each other in part in a second scanning direction. The overlaps are denoted as double portions 633a and 633b. In the above case, the double portion 633a is the overlap between the LPH bar 631a and the LPH bar 631b in the second scanning direction. The double portion 633b is the overlap between the LPH bar 631b and the LPH bar 631c in the second scanning direction.

Hereinafter, the LPH bars 631a to 631c may be simply referred to as LPH bars 631 if they are not distinguished from one another. Likewise, the focus adjusting pins 632a and 632b may be hereinafter simply referred to as focus adjusting pins 632 if they are not distinguished from each other. Furthermore, the double portions 633a and 633b may be hereinafter simply referred to as double portions 633 if they are not distinguished from each other.

FIG. 3B is an enlargement of a part of the light emitting unit 63 seen in a direction of arrow IIIB illustrated in FIG. 3A. FIG. 3B illustrates the double portion 633a between the LPH bar 631a and the LPH bar 631b.

As illustrated in FIG. 3B, the LPH bar 631a and the LPH bar 631b each include light emitting chips C as exemplary light-emitting-device-array chips. The light emitting chips C are arranged in two rows extending in the first scanning direction and staggered with respect to each other. The LPH bar 631a and the LPH bar 631b each include, for example, sixty light emitting chips C. Hereinafter, the sixty light emitting chips C may be individually denoted as light emitting chips C1 to C60. As illustrated in FIG. 3B, the light emitting chips C each include LEDs 71. Specifically, in the present exemplary embodiment, a predetermined number of LEDs 71 are mounted on each of the light emitting chips C and are arranged in lines extending in the first scanning direction. The LEDs 71 are lit up in units of one light emitting chip C sequentially in the first scanning direction or in a direction opposite to the first scanning direction.

The LPH bar 631c (not illustrated in FIG. 3B) has the same configuration as the LPH bar 631a and the LPH bar 631b. The double portion 633b has the same configuration as the double portion 633a.

In the above configuration, the group of LEDs 71 mounted on each of the LPH bar 631a and the LPH bar 631c is regarded as a first light-emitting-device arrangement including a plurality of LEDs 71 arranged in lines extending in the first scanning direction. The group of LEDs 71 mounted on the LPH bar 631b overlaps each of the first light-emitting-device arrangements in the second scanning direction at least in part and is regarded as a second light-emitting-device arrangement including a plurality of LEDs 71 arranged in lines extending in the first scanning direction.

The double portions 633a and 633b are each regarded as an exemplary overlapping portion where the first light-emitting-device arrangement and the second light-emitting-device arrangement overlap each other.

The first light-emitting-device arrangement and the second light-emitting-device arrangement may each be described as a structure obtained by arranging the light emitting chips C each including the LEDs 71 arranged in lines extending in the first scanning direction.

The light-emitting-device arrangement to be lit up is switched between the first light-emitting-device arrangement and the second light-emitting-device arrangement at a switching position Kp defined at any position in each of the double portions 633a and 633b. In short, the LPH bar 631 to be lit up is changed at the switching position Kp. In this case, the LPH bar 631 carrying the LEDs 71 to be lit up is switched in order of the LPH bar 631a, the LPH bar 631b, and the LPH bar 631c.

In FIG. 3B, the LEDs 71 illustrated as white dots are lit up, whereas the LEDs 71 illustrated as black dots are not lit up. That is, FIG. 3B illustrates a case where the LEDs 71 to be lit up are switched at the switching position Kp from those on the LPH bar 631a to those on the LPH bar 631b. On the left side with respect to the switching position Kp in FIG. 3B, the LEDs 71 on the LPH bar 631a are lit up. On the right side with respect to the switching position Kp in FIG. 3B, the LEDs 71 on the LPH bar 631b are lit up.

The switching position Kp is arbitrarily settable within each of the double portions 633a and 633b. The operation of controlling the switching is undergone by the signal generating circuit 100. Therefore, the signal generating circuit 100 serves as a switching unit that switches the light-emitting-device arrangement to be lit up between the first light-emitting-device arrangement and the second light-emitting-device arrangement at the switching position Kp.

The focus adjusting pins 632a and 632b allow the circuit board 62 to move in the up-and-down direction as indicated by double-headed arrow illustrated in FIG. 3A. In short, the circuit board 62 is movable up and down. The distance between the light emitting unit 63 and the photoconductor drum 12 is changeable by moving the circuit board 62 up and down. Hence, the distance between the photoconductor drum 12 and the LPH bars 631a to 631c is changeable to adjust the focus of the light emitted from the LEDs 71 to the photoconductor drum 12. With the focus adjusting pins 632a and 632b, both a side of the circuit board 62 that is nearer to the focus adjusting pin 632a and a side of the circuit board 62 that is nearer to the focus adjusting pin 632b may be moved upward. Furthermore, both the side of the circuit board 62 that is nearer to the focus adjusting pin 632a and the side of the circuit board 62 that is nearer to the focus adjusting pin 632b may be moved downward. Furthermore, while one of the side of the circuit board 62 that is nearer to the focus adjusting pin 632a and the side of the circuit board 62 that is nearer to the focus adjusting pin 632b is moved upward, the other may be moved downward. The focus adjusting pins 632a and 632b may be controlled by the signal generating circuit 100 or by manual operation.

The pair of focus adjusting pins 632a and 632b may be regarded as an exemplary up-and-down mechanism that moves at least one of the first light-emitting-device arrangement and the second light-emitting-device arrangement up and down.

### Description of Light-Emitting-Device-Array Chip

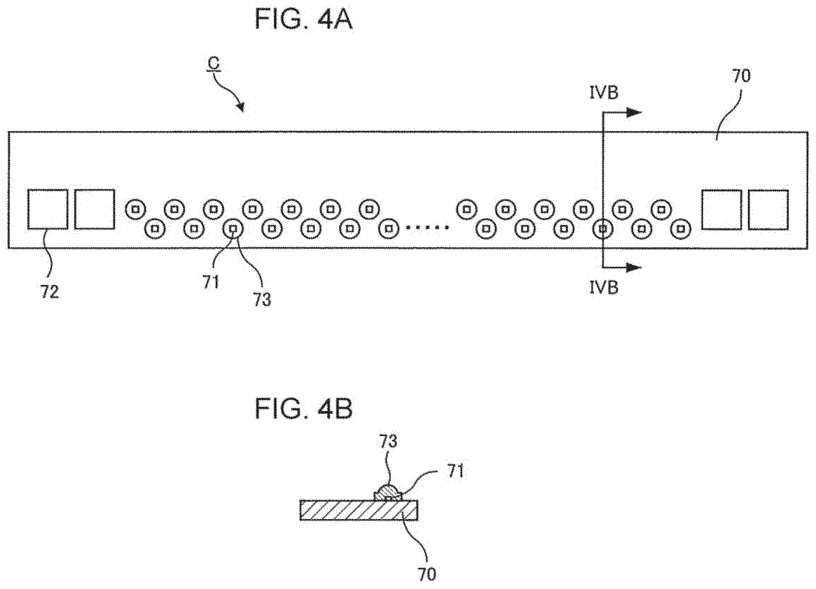

FIGS. 4A and 4B illustrate a configuration of the light emitting chip C to which the exemplary embodiment is applied.

FIG. 4A illustrates the light emitting chip C seen from a side toward which the LEDs 71 emit light. FIG. 4B is a sectional view taken along line IVB-IVB illustrated in FIG. 4A.

The light emitting chip C includes a plurality of LEDs 71 arranged in lines and at regular intervals in the first scanning direction, thereby forming an exemplary light-emitting-device array. The light emitting chip C further includes bonding pads 72 provided at both ends of a substrate 70, with the light-emitting-device array positioned in between. The bonding pads 72 each serve as an exemplary electrode provided for inputting and outputting signals for driving the light-emitting-device array. Each of the LEDs 71 has a microlens 73 on a side thereof toward which light is emitted. The light emitted from the LEDs 71 is condensed by the microlenses 73 and is efficiently applied to the photoconductor drum 12 (see FIG. 2).

The microlens 73 is made of transparent resin such as photocurable resin and may have an aspherical surface for highly efficient condensation of light. The size, thickness, focal length, and other relevant factors of the microlenses 73 are determined by the wavelength of the LEDs 71 to be used, the refractive index of the photocurable resin to be used, and the like.

### Description of Self-Scanning Light-Emitting-Device-Array Chip

In the present exemplary embodiment, a self-scanning light-emitting-device (SLED)-array chip may be employed as the light-emitting-device-array chip exemplified as the light emitting chip C. The self-scanning light-emitting-device-array chip as the light-emitting-device-array chip employs light emitting thyristors each having a pnpn structure, so that a self-scanning operation of the light emitting devices is realized.

FIG. 5 illustrates a configuration of the signal generating circuit 100 and a wiring scheme of the circuit board 62 in a case where self-scanning light-emitting-device-array chips are employed as the light emitting chips C.

The signal generating circuit 100 receives various control signals, such as a line synchronization signal Lsync; image data Vdata; a clock signal clk; and a reset signal RST, from the image output controller 200 (see FIG. 1). In accordance with the control signals inputted from the external apparatus, the signal generating circuit 100 undergoes relevant operations such as adjustment of the order of pieces of image data Vdata and correction of output values, and outputs light emission signals φI (φI1 to φI60) to the light emitting chips C (C1 to C60), respectively. In the present exemplary embodiment, each of the light emitting chips C (C1 to C60) is supplied with one light emission signal φI (a corresponding one of signals φI1 to φI60).

Furthermore, in accordance with the control signals inputted from the external apparatus, the signal generating circuit 100 outputs a start transfer signal φS, a first transfer signal φ1, and a second transfer signal φ2 to the light emitting chips C1 to C60.

The circuit board 62 is provided with a power supply line 101 for power supply and a power supply line 102 for grounding. The power supply line 101 is connected to Vcc terminals of the light emitting chips C1 to C60, where Vcc=−5.0 V. The power supply line 102 is connected to GND terminals. Furthermore, the circuit board 62 is provided with a start-transfer-signal line 103 that transmits the start transfer signal φS, the first transfer signal φ1, and the second transfer signal φ2 that are generated by the signal generating circuit 100; a first-transfer-signal line 104; and a second-transfer-signal line 105. Furthermore, the circuit board 62 is provided with sixty light-emission-signal lines 106 (106_1 to 106_60) through which the signal generating circuit 100 outputs the light emission signals φI φI1 to φI60) to the light emitting chips C (C1 to C60), respectively. Note that the circuit board 62 is provided with sixty light-emission-current-limiting resistors RID for suppressing excessive flow of current to the sixty light-emission-signal lines 106 (106_1 to 106_60). As to be described separately below, the level of each of the light emission signals φI1 to φI60 is changeable between a high level (H) and a low level (L). The low level corresponds to a potential of −5.0 V. The high level corresponds to a potential of +/−0.0 V.

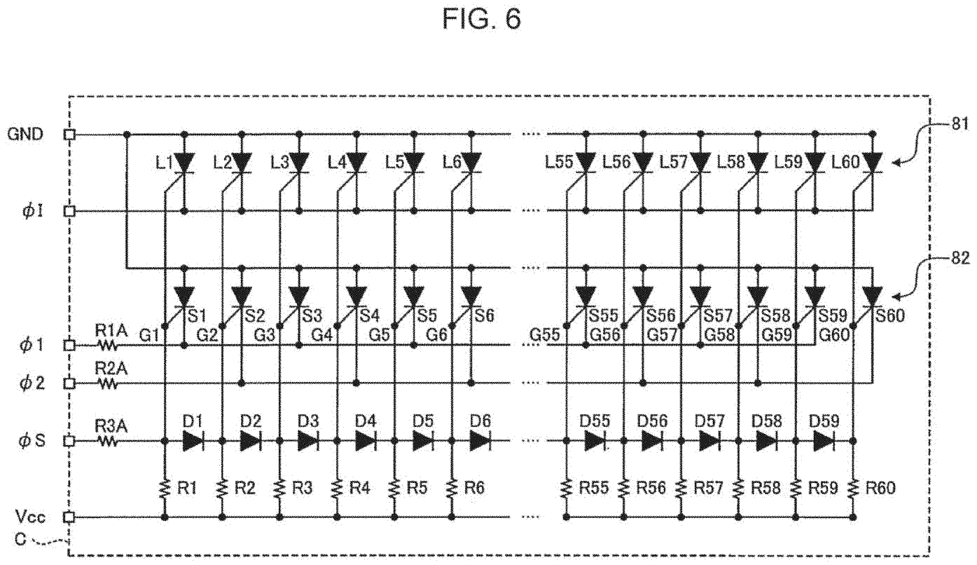

FIG. 6 illustrates a circuit configuration of each of the light emitting chips C (C1 to C60).

The light emitting chip C includes sixty transfer thyristors S1 to S60, and sixty light emission thyristors L1 to L60. The light emission thyristors L1 to L60 each have the same pnpn structure as the transfer thyristors S1 to S60 and serve as a light emitting diode (LED) when using a pn structure included therein. The light emitting chip C further includes fifty-nine diodes D1 to D59 and sixty resistors R1 to R60. The light emitting chip C further includes transfer-current-limiting resistors R1A, R2A, and R3A for suppressing excessive flow of current to the signal lines to be supplied with the first transfer signal φ1, the second transfer signal φ2, and the start transfer signal φS. The light emission thyristors L1 to L60, which form a light-emitting-device array 81, are arranged in order of L1, L2, . . . , L59, and L60 from the left side in FIG. 6, forming a light-emitting-device arrangement. The transfer thyristors S1 to S60 are also arranged in order of S1, S2, . . . , S59, and S60 from the left side in FIG. 6, forming a switching-device arrangement, i.e. a switching device array 82. The diodes D1 to D59 are also arranged in order of D1, D2, . . . , D58, and D59 from the left side in FIG. 6. The resistors R1 to R60 are also arranged in order of R1, R2, . . . , R59, and R60 from the left side in FIG. 6.

Now, an electrical connection of the devices included in the light emitting chip C will be described.

Anode terminals of the transfer thyristors S1 to S60 are connected to the GND terminal. The power supply line 102 (see FIG. 5) is connected to the GND terminal, which is thus grounded.

Cathode terminals of odd-number transfer thyristors S1, S3, . . . , and S59 are connected to a φ1 terminal through the transfer-current-limiting resistor R1A. The first-transfer-signal line 104 (see FIG. 5) is connected to the φ1 terminal, which is thus supplied with the first transfer signal φ1.

On the other hand, cathode terminals of even-number transfer thyristors S2, S4, . . . , and S60 are connected to a φ2 terminal through the transfer-current-limiting resistor R2A. The second-transfer-signal line 105 (see FIG. 5) is connected to the φ2 terminal, which is thus supplied with the second transfer signal φ2.

Gate terminals G1 to G60 of the transfer thyristors S1 to S60 are connected to the Vcc terminal through the resistors R1 to R60 provided in correspondence with the transfer thyristors S1 to S60. The power supply line 101 (see FIG. 5) is connected to the Vcc terminal, which is thus supplied with a power supply voltage Vcc (−5.0 V).

The gate terminals G1 to G60 of the transfer thyristors S1 to S60 are connected to gate terminals of the light emission thyristors L1 to L60, respectively, which are denoted by corresponding reference numerals.

Anode terminals of the diodes D1 to D59 are connected to the gate terminals G1 to G59 of the transfer thyristors S1 to S59. Cathode terminals of the diodes D1 to D59 are connected to the gate terminals G2 to G60 of the transfer thyristors S2 to S60, which are adjacent to the transfer thyristors S1 to S59, respectively. That is, the diodes D1 to D59 are connected in series, with the gate terminals G1 to G60 of the transfer thyristors S1 to S60 each interposed between adjacent ones of the diodes D1 to D59.

The anode terminal of the diode D1, i.e. the gate terminal G1 of the transfer thyristor S1, is connected to a φS terminal through the transfer-current-limiting resistor R3A. The φS terminal is supplied with the start transfer signal φS through the start-transfer-signal line 103 (see FIG. 5).

Anode terminals of the light emission thyristors L1 to L60 are connected to the GND terminal, as with the anode terminals of the transfer thyristors S1 to S60.

Cathode terminals of the light emission thyristors L1 to L60 are connected to a φI terminal. The light-emission-signal line 106 (in the light emitting chip C1, the light-emission-signal line 106_1: see FIG. 5) is connected to the φI terminal, which is supplied with the light emission signal φI (in the light emitting chip C1, the light emission signal φI1). Note that the other light emitting chips C2 to C60 are supplied with the light emission signals φI2 to I60, respectively.

### Description of Density Variation at Switching Position Kp

In the present exemplary embodiment, as described above, the LPH bar 631 carrying the LEDs 71 to be lit up is switched in order of the LPH bar 631a, the LPH bar 631b, and the LPH bar 631c. In such a switching process, however, the focus may vary among the LPH bars 631. If the focus varies, the density of the image formed on the sheet P varies.

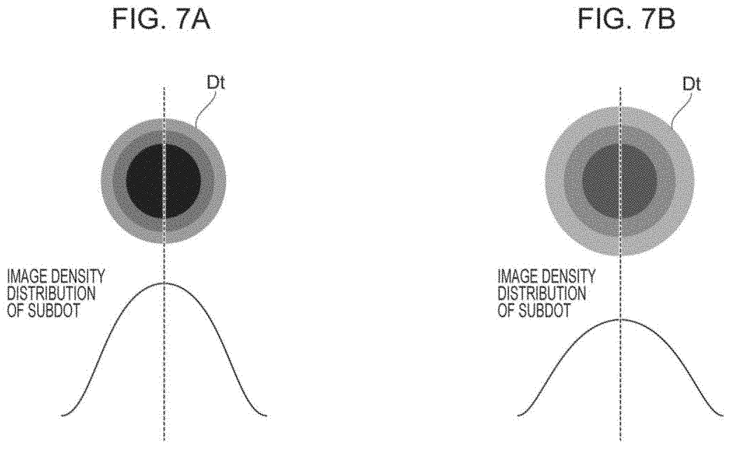

FIGS. 7A and 7B illustrate the relationship between a defocused image and the density thereof.

The image formed by the above image forming apparatus 1 is composed of dots. The dots are each composed of a plurality of subdots Dt. FIG. 7A illustrates the shape and image density distribution of a subdot Dt that is in focus. FIG. 7B illustrates the shape and image density distribution of a subdot Dt that is out of focus.

As illustrated in FIG. 7A, if the subdot Dt is in focus, the light quantity distribution around the subdot Dt is narrower, and the image density distribution of the subdot Dt is narrower. Therefore, the subdot Dt tends to be smaller. In contrast, as illustrated in FIG. 7B, if the subdot Dt is out of focus, the light quantity distribution around the subdot Dt is broader, and the image density distribution of the subdot Dt is broader. Therefore, the subdot Dt tends to be larger. That is, if the focus varies, the image density distribution and size of the dots to be formed vary. Consequently, the resulting image has density variations.

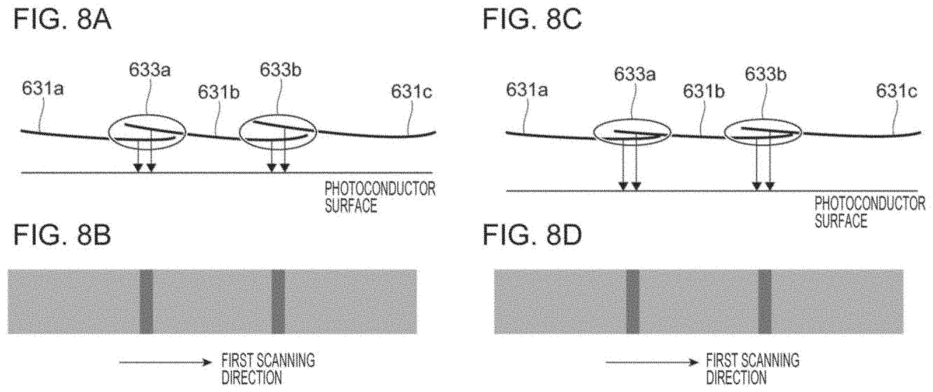

FIGS. 8A to 8D illustrate focus variations between adjacent ones of the LPH bars 631 and an image formed with the focus variations.

In particular, FIG. 8A illustrates a case where there are focus variations because the focal length varies in each of the double portions 633 where the LPH bars 631 adjacent to one another overlap one another. In FIG. 8A, the length of each arrow represents the focal length, which varies in the first scanning direction. In this case, the focal length varies in each of the double portions 633a and 633b where the LPH bars 631a to 631c overlap one another. Consequently, there are focus variations.

Accordingly, density variation occurs at each of the switching positions Kp defined in the respective double portions 633a and 633b. Consequently, as illustrated in FIG. 8B, the resulting image has a different density in the double portions 633a and 633b.

FIG. 8C illustrates a case where there are focus variations because the focal length originally varies with the LPH bars 631. In FIG. 8C as well, the length of each arrow represents the focal length, which varies in the first scanning direction. In this case as well, the focal length varies in each of the double portions 633a and 633b where the LPH bars 631a to 631c overlap one another. Consequently, there are focus variations.

Accordingly, density variation occurs at each of the switching positions Kp defined in the respective double portions 633a and 633b. Consequently, as illustrated in FIG. 8D, the resulting image has a different density in the double portions 633a and 633b.

### Description of Method of Correcting Density Variation at Switching Position Kp

In view of the above problem, the present exemplary embodiment employs an acquiring unit that acquires information on density variation at the switching position Kp occurring in the image formed on the sheet P, and a correcting unit that corrects the density variation with reference to the information on density variation.

The acquiring unit is, for example, the image reading device 300. Alternatively, the acquiring unit may be, for example, the UI 400.

The correcting unit is, for example, a changing mechanism that changes the distance between the photoconductor and the first and second light-emitting-device arrangements. Specifically, the changing mechanism is, for example, the pair of focus adjusting pins 632a and 632b illustrated in FIG. 3A. Moving the circuit board 62 up and down by using the focus adjusting pins 632a and 632b changes the distance between the light emitting unit 63 and the photoconductor drum 12. The changing mechanism is not limited to the pair of focus adjusting pins 632a and 632b. For example, the changing mechanism may be a mechanism that changes the distance between the light emitting unit 63 and the photoconductor drum 12 by moving the photoconductor drum 12.

As illustrated in FIG. 3A, the pair of focus adjusting pins 632a and 632b serves as a mechanism that allows the circuit board 62 to move up and down. With the up and down movement of the circuit board 62, the LPH bars 631a to 631c are moved up and down. In other words, the focus adjusting pins 632a and 632b allow both the first light-emitting-device arrangement and the second light-emitting-device arrangement to move up and down.

The up-and-down mechanism may be a mechanism that moves the LPH bars 631a to 631c up and down individually. Such an up-and-down mechanism is realized by, for example, providing the focus adjusting pins 632 at two respective long-side ends of each of the LPH bars 631a to 631c. In such a case, the distance between the light emitting unit 63 and the photoconductor drum 12 is changeable for each of the LPH bars 631a to 631c. Therefore, compared to the up-and-down mechanism as the pair of focus adjusting pins 632a and 632b illustrated in FIG. 3A, finer adjustment of the distance between the light emitting unit 63 and the photoconductor drum 12 is achieved.

The correcting unit may be, for example, a light-quantity-correcting mechanism that corrects the light quantity of the LEDs 71 that are adjacent to the switching position Kp. Specifically, the correcting unit corrects the light quantity of the LEDs 71 that are adjacent to the switching position Kp such that the above density variation is corrected. The light-quantity-correcting mechanism may be regarded as one of functions of the signal generating circuit 100.

### Description of Functional Configuration of Signal Generating Circuit 100

A functional configuration of the signal generating circuit 100 that performs a process of correcting density variation occurring at the switching position Kp will now be described.

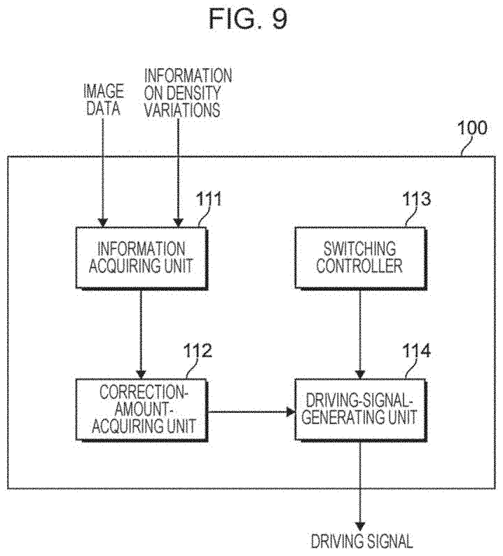

FIG. 9 is a block diagram illustrating an exemplary functional configuration of the signal generating circuit 100 according to the exemplary embodiment. Note that FIG. 9 illustrates only some of various functions of the signal generating circuit 100 that are relevant to the present exemplary embodiment.

As illustrated in FIG. 9, the signal generating circuit 100 includes an information acquiring unit 111 that acquires information such as image data, a correction-amount-acquiring unit 112 that calculates the correction amount for correcting the density variation, a switching controller 113 that controls the operation of switching the LEDs 71 to be lit up among those on different LPH bars 631, and a driving-signal-generating unit 114 that generates driving signals.

The information acquiring unit 111 receives image data from the image output controller 200. As described above, the image data is inputted from the external apparatus such as a PC and is subjected to an imaging process and the like performed by the image output controller 200, so that the image data is usable in forming an image by the image forming units 11. Specific examples of the imaging process include rasterization, color conversion, pile-height measurement, screening, and the like.

The information acquiring unit 111 further acquires information on density variation at the switching position Kp from the image reading device 300 or the UI 400 serving as the correcting unit.

The correction-amount-acquiring unit 112 calculates the correction amount for correcting the density variation with reference to the information on density variation at the switching position Kp that has been acquired by the information acquiring unit 111. If the correcting unit is the changing mechanism that changes the distance between the photoconductor and the first and second light-emitting-device arrangements, the correction amount corresponds to the amount of change in the distance. If the correcting unit is the pair of focus adjusting pins 632a and 632b, the correction amount corresponds to the amount of up-and-down movement of the circuit board 62. If the correcting unit is the light-quantity-correcting mechanism, the amount of correction corresponds to the light quantity of the LEDs 71 that are adjacent to the switching position Kp.

The switching controller 113 controls the operation of switching the LPH bar 631 to be lit up at the switching position Kp.

The driving-signal-generating unit 114 generates driving waveforms for lighting up the LEDs 71 and outputs the driving waveforms as driving signals. Specifically, for example, the driving-signal-generating unit 114 generates driving waveforms of the light emission signal φI, the start transfer signal φS, the first transfer signal φ1, and the second transfer signal φ2 described above and outputs these signals as driving signals. If the correcting unit is the light-quantity-correcting mechanism, the driving-signal-generating unit 114 outputs driving signals corresponding to the correction amount for the light quantity of the LEDs 71. Specifically, the light quantity of the LEDs 71 is corrected by adjusting at least one of the voltage, current, and output duration of the driving signals.

### Description of Operation of Image Forming Apparatus 1

An operation executed by the image forming apparatus 1 in correcting the density variation occurring at the switching position Kp will now be described.

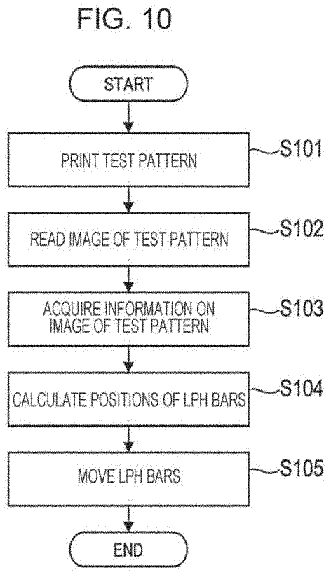

FIG. 10 is a flow chart of an operation executed by the image forming apparatus 1 in a case where the acquiring unit is the image reading device 300 and the correcting unit is the pair of focus adjusting pins 632a and 632b.

First, the focus adjusting pins 632a and 632b are moved to move the circuit board 62 up and down by different predetermined lengths, and a test pattern is printed at the respective positions (step 101).

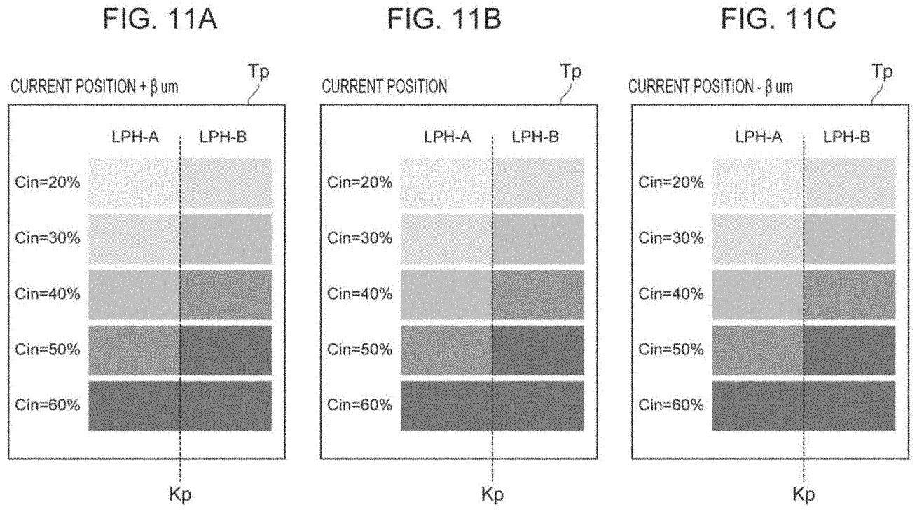

FIGS. 11A to 11C illustrate images Tp of the test pattern that are printed in step 101. The test pattern is a gray-scale image whose density is varied among 20%, 30%, 40%, 50%, and 60%.

FIG. 11B illustrates an image Tp of the test pattern printed without moving the focus adjusting pins 632a and 632b. FIG. 11A illustrates an image Tp of the test pattern printed with the circuit board 62 moved upward by β μm (+β μm) by moving the focus adjusting pins 632a and 632b. FIG. 11C illustrates an image Tp of the test pattern printed with the circuit board 62 move downward by μ μm (−β μm) by moving the focus adjusting pins 632a and 632b.

FIGS. 11A to 11C each illustrate that the density of the image Tp of the test pattern changes at the switching position Kp.

Referring to FIG. 10 again, the image reading device 300 then reads the images Tp of the test pattern (step 102).

Subsequently, the information acquiring unit 111 of the signal generating circuit 100 acquires information on the images Tp of the test pattern from the image reading device 300 (step 103).

Furthermore, with reference to the result of the reading of the test pattern, the correction-amount-acquiring unit 112 calculates which positions of the LPH bars 631a to 631c eliminate the density variation (step 104).

Then, the LPH bars 631a to 631c are moved to the calculated positions by using the focus adjusting pins 632a and 632b (step 105).

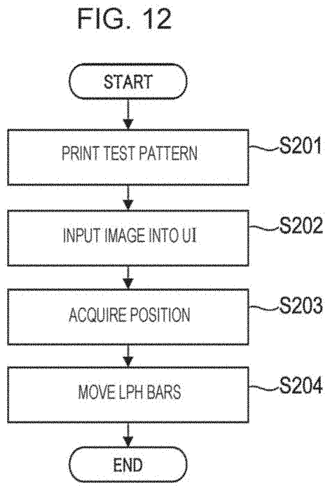

FIG. 12 is a flow chart of an operation executed by the image forming apparatus 1 in a case where the acquiring unit is the UI 400 and the correcting unit is the pair of focus adjusting pins 632a and 632b.

First, the focus adjusting pins 632a and 632b are moved to move the circuit board 62 up and down by different predetermined lengths, and, as illustrated in FIGS. 11A to 11C, a test pattern is printed at the respective positions (step 201).

Subsequently, the user checks the images Tp of the test pattern and selects one of the images Tp of the test pattern whose density variation at the switching position Kp is the smallest. Then, the user inputs the selected image Tp into the UI 400 (step 202). This step may also be described as follows: with reference to visual inspection by the user as the information on density variation at the switching position Kp, the UI 400 as the acquiring unit acquires information on the positions of the LPH bars 631a to 631c where the density variation at the switching position Kp is smallest.

Then, the correction-amount-acquiring unit 112 acquires the position of the circuit board 62 where the density variation at the switching position Kp is smallest (step 203).

Furthermore, the LPH bars 631a to 631c are moved to the acquired positions by using the focus adjusting pins 632a and 632b.

In the exemplary embodiment illustrated in FIGS. 11A to 11C and FIG. 12, the above step may also be described as follows: the image reading device 300 or the UI 400 as the acquiring unit acquires the information on density variation at the switching position Kp in the image on the sheet P when the distance between the photoconductor and at least one of the first light-emitting-device arrangement and the second light-emitting-device arrangement is changed.

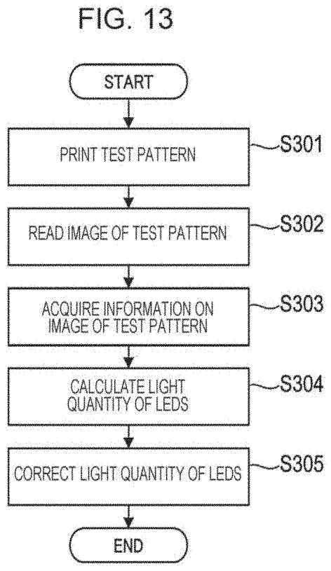

FIG. 13 is a flow chart of an operation executed by the image forming apparatus 1 in a case where the acquiring unit is the image reading device 300 and the correcting unit is the light-quantity-correcting mechanism.

First, a test pattern is printed without moving the focus adjusting pins 632a and 632b (step 301). In this step, the test pattern is printed as illustrated in FIG. 11B.

Subsequently, the image reading device 300 reads the image Tp of the test pattern (step 302). This step may also be described as follows: the image reading device 300 as the acquiring unit acquires the information on density variation at the switching position Kp in the image on the sheet P when the distance between the photoconductor and the first and second light-emitting-device arrangements is unchanged.

Subsequently, the information acquiring unit 111 of the signal generating circuit 100 acquires information on the image of the test pattern from the image reading device 300 (step 303).

Furthermore, with reference to the result of the reading of the test pattern, the correction-amount-acquiring unit 112 calculates what light quantity of the LEDs 71 eliminates the density variation (step 304).

Furthermore, the driving-signal-generating unit 114 corrects the light quantity of the LEDs 71 to the light quantity calculated by the correction-amount-acquiring unit 112 (step 305).

In this step, not only the light quantity of the LEDs 71 in the double portions 633 but also the light quantity of the LEDs 71 adjacent to the double portions 633 is corrected.

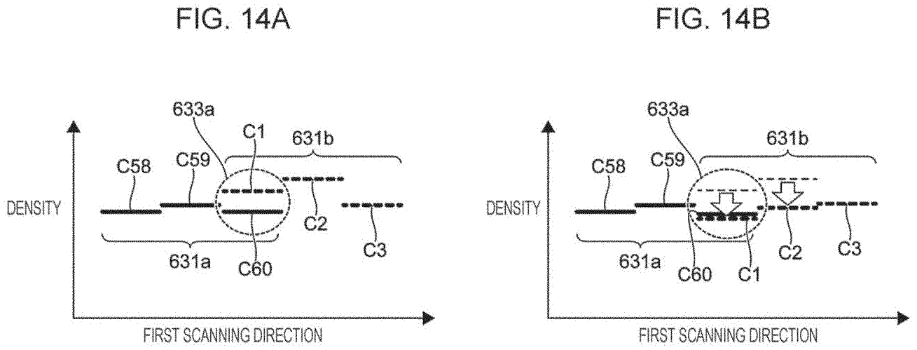

FIGS. 14A and 14B each illustrate how to correct the light quantity of the LEDs 71 positioned in the double portion 633 and the LEDs 71 positioned adjacent to the double portion 633. Herein, image density variation in the first scanning direction will be discussed.

FIG. 14A illustrates the image density before the light quantity is corrected. In FIG. 14A, the density varies in the double portion 633a between the LPH bar 631a and the LPH bar 631b. In other words, the density of LEDs 71 in the double portion 633a is different between the light emitting chip C60 on the LPH bar 631a and the light emitting chip C1 on the LPH bar 631b.

FIG. 14B illustrates the image density after the light quantity is corrected. In FIG. 14B, the light quantity of the LEDs 71 in the light emitting chip C1 on the LPH bar 631b is corrected to be equal to the light quantity of the LEDs 71 in the light emitting chip C60 on the LPH bar 631a. Nevertheless, correcting only the light quantity of the LEDs 71 in the light emitting chip C1 on the LPH bar 631b leads to a density variation between the LEDs 71 in the light emitting chip C1 and the LEDs 71 in the light emitting chip C2 adjacent to the light emitting chip C1. Therefore, not only the light quantity of the LEDs 71 in the light emitting chip C positioned in the double portion 633 but also the light quantity of the LEDs 71 in the light emitting chip C adjacent to the double portion 633 is corrected. In the case illustrated in FIG. 14B, the light quantity of the LEDs 71 in both the light emitting chip C1 and the light emitting chip C2 on the LPH bar 631b is corrected.

According to the above exemplary embodiment, the image forming apparatus 1 and the light-emitting-device head 14 are realized such that the image formed on the sheet P is less likely to have density variations at each switching position Kp where the set of the LEDs 71 to be lit up is switched.

While the above exemplary embodiment concerns the correction of density variation in the double portion 633 between different LPH bars 631, the present disclosure is also applicable to the correction of density variation between different light emitting chips C.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image forming apparatus comprising:
a toner-image-forming unit that forms a toner image by using a first light-emitting-device arrangement and a second light-emitting-device arrangement in each of which light-emitting devices are arranged in lines extending in a first scanning direction, the second light-emitting-device arrangement overlapping the first light-emitting-device arrangement in a second scanning direction at least in part, and an optical device that forms an electrostatic latent image by focusing light emitted from the light-emitting devices on a photoconductor and exposing the photoconductor to the light;
a transfer unit that transfers the toner image to a recording medium;
a fixing unit that fixes the toner image transferred to the recording medium and finishes the image;
a switching unit that switches the light-emitting-device arrangement to be lit up between the first light-emitting-device arrangement and the second light-emitting-device arrangement at a switching position defined at any position in an overlapping portion where the first light-emitting-device arrangement and the second light-emitting-device arrangement overlap each other;
an acquiring unit that acquires information on density variation at the switching position in the image formed on the recording medium; and
a correcting unit that corrects the density variation with reference to the information on density variation.

2. The image forming apparatus according to claim 1, wherein the correcting unit is a changing mechanism that changes a distance between the photoconductor and the first and second light-emitting-device arrangements.

3. The image forming apparatus according to claim 2, wherein the changing mechanism is an up-and-down mechanism that moves at least one of the first light-emitting-device arrangement and the second light-emitting-device arrangement up and down.

4. The image forming apparatus according to claim 3, wherein the up-and-down mechanism moves both the first light-emitting-device arrangement and the second light-emitting-device arrangement up and down.

5. The image forming apparatus according to claim 1, wherein the correcting unit is a light-quantity-correcting mechanism that corrects light quantity of the light emitting devices that are adjacent to the switching position.

6. The image forming apparatus according to claim 1, wherein the acquiring unit acquires the information on density variation at the switching position in the image formed on the recording medium when a distance between the photoconductor and at least one of the first light-emitting-device arrangement and the second light-emitting-device arrangement is changed.

7. The image forming apparatus according to claim 6, wherein, with reference to visual inspection by a user as the information on density variation at the switching position, the correcting unit moves at least one of the first light-emitting-device arrangement and the second light-emitting-device arrangement to a position where the density variation at the switching position is smallest.

8. The image forming apparatus according to claim 6, wherein when the distance between the photoconductor and the first and second light-emitting-device arrangements is changed, the correcting unit moves at least one of the first light-emitting-device arrangement and the second light-emitting-device arrangement to a position where the density variation is eliminated, the position being calculated from a result of reading of the image.

9. The image forming apparatus according to claim 6, wherein, with reference to a result of reading of the image obtained when the distance between the photoconductor and the first and second light-emitting-device arrangements is unchanged, the correcting unit corrects a light quantity of the light emitting devices to a light quantity with which the density variation is eliminated.

10. The image forming apparatus according to claim 9, wherein the correcting unit corrects the light quantity of the light emitting devices positioned in the overlapping portion and the light quantity of the light emitting devices positioned adjacent to the overlapping portion.

11. The image forming apparatus according to claim 1, wherein the first light-emitting-device arrangement and the second light-emitting-device arrangement are each a structure obtained by arranging light-emitting-device-array chips each including the light emitting devices arranged in lines extending in the first scanning direction.

12. A light-emitting-device head comprising:
a first light-emitting-device arrangement including light emitting devices arranged in lines extending in a first scanning direction;
a second light-emitting-device arrangement including light emitting devices arranged in lines extending in the first scanning direction, the second light-emitting-device arrangement overlapping the first light-emitting-device arrangement in a second scanning direction at least in part;
an optical device that forms an electrostatic latent image by focusing light emitted from the light emitting devices on a photoconductor and exposing the photoconductor to the light; and
a switching unit that switches the light-emitting-device arrangement to be lit up between the first light-emitting-device arrangement and the second light-emitting-device arrangement at a switching position defined at any position in an overlapping portion where the first light-emitting-device arrangement and the second light-emitting-device arrangement overlap each other; and
a correcting unit that corrects, at the switching position, density variation occurring in an image formed on a recording medium.

13. An image forming apparatus comprising:
means for forming a toner image by using a first light-emitting-device arrangement and a second light-emitting-device arrangement in each of which light-emitting devices are arranged in lines extending in a first scanning direction, the second light-emitting-device arrangement overlapping the first light-emitting-device arrangement in a second scanning direction at least in part, and an optical device that forms an electrostatic latent image by focusing light emitted from the light-emitting devices on a photoconductor and exposing the photoconductor to the light;
means for transferring the toner image to a recording medium;
means for fixing the toner image transferred to the recording medium and finishes the image;
means for switching the light-emitting-device arrangement to be lit up between the first light-emitting-device arrangement and the second light-emitting-device arrangement at a switching position defined at any position in an overlapping portion where the first light-emitting-device arrangement and the second light-emitting-device arrangement overlap each other;
means for acquiring information on density variation at the switching position in the image formed on the recording medium; and
means for correcting the density variation with reference to the information on density variation.
